(19) United States
(12) Patent Application Publication
(10) Pub. No.: US 2026/0085712 A1
(43) Pub. Date: Mar. 26, 2026

(54) FASTENING STRUCTURE

(71) Applicants: NIFCO INC., Yokosuka-shi (JP); NISSAN MOTOR CO., LTD., Yokohama-shi (JP)

(72) Inventors: Yuto KIMURA, Yokosuka-shi (JP); Yuji ISHII, Yokohama-shi (JP)

(21) Appl. No.: 19/181,331

(22) Filed: Apr. 17, 2025

(30) Foreign Application Priority Data
Apr. 18, 2024 (JP) 2024-067260

(51) Int. Cl. F16B 21/06; F16B 21/02; F16B 21/09

(52) U.S. Cl. CPC F16B 21/065; F16B 21/02; F16B 21/09

(57) ABSTRACT

A fastening structure is firmly attached to one attached member and easily attached to the other attached member. With a fastening structure, a second attached member is connected to a first attached member, via a clip, in a posture facing the first attached member with a gap interposed therebetween. The clip is constituted by two members of a grommet member and a pin member. When a first engagement portion of the clip is attached to the first attached member in a non-expanded diameter state and the pin member is pushed in to deform the first engagement portion into an expanded diameter state, the clip engages with the first attached member and the second attached member is attached to a second engagement portion of the clip. When the clip rotates, the clip engages with the second attached member.

### CROSS-REFERENCE TO RELATED APPLICATION

The invention claims priority of Japanese Patent Application No. 2024-067260 filed on Apr. 18, 2024, the disclosure of which is incorporated herein.

### BACKGROUND OF THE INVENTION

### 1. Field of the Invention

The present invention relates to a fastening structure to attach one member to another member.

### 2. Description of the Related Art

Conventionally, an undercover of an automobile has an opening to expose a jack-up point, and the opening is closed with a lid cover. The lid cover is attached to a side sill cover or the like via a clip and is removed at the time of a jack-up operation. As the clip used to attach one member (such as the lid cover) to and remove it from another member (such as the side sill cover), for example, a technology described in Japanese Patent Application Laid-open Publication No. 2009-115148 (hereinafter, referred to as “invention known in JP-A-2009-115148”) is present.

The clip according to the invention known in JP-A-2009-115148 is interposed between two panels and includes an insert that is inserted into a hole in one of the panels and a fastener that is inserted into a hole in the other of the panels. First, the insert is attached to the one of the panels, and in this state, the other of the panels is attached to the fastener. Specifically, the clip according to the invention known in JP-A-2009-115148 is made of a resin, and the insert includes an elastic piece that is slightly larger than the hole in the one of the panels. The elastic piece is slightly elastically deformed when being inserted into the hole and is restored to the original state after passing through the hole, thereby engaging with an edge of the hole.

Patent Document 1: Japanese Patent Application Laid-open Publication No. 2009-115148

However, as described above, in the invention known in JP-A-2009-115148, since the elastic piece engages with the edge of the hole due to a slight difference in size before and after the elastic deformation, the elastic piece easily disengages from the hole. In addition, when the other of the panels is attached to the fastener after the insert is attached to the one of the panels, the other of the panels may rotate with the insert serving as the axis of rotation, making it difficult for the other of the panels to be attached to the fastener.

### SUMMARY OF THE INVENTION

The present invention has been made in view of such circumstances, and it is an object thereof to provide a fastening structure that can be firmly attached to one attached member and easily attached to another attached part.

In order to achieve the object described above, a fastening structure according to the present invention is a fastening structure for attaching a second attached member to a first attached member facing the second attached member by being brought into a first attached member engagement state in which the fastening structure is inserted into a first attachment hole formed in the first attached member and engages with the first attached member and into a second attached member engagement state in which the fastening structure is inserted into a second attachment hole formed in the second attached member and engages with the second attached member. The fastening structure includes a grommet member and a pin member connected to each other in advance, in which the grommet member includes a body in which an insert hole is formed and that is attached to the first attached member, a plurality of legs that extends from around the insert hole and is inserted into the first attachment hole, and an arm that is formed opposite the legs with respect to the body and is inserted into the second attachment hole; the pin member includes a shaft inserted in the insert hole; and a first engagement portion including the legs and the shaft is brought into the first attached member engagement state by being inserted into the first attachment hole in a non-expanded diameter state capable of being inserted into the first attachment hole and being brought into an expanded diameter state in which the shaft is pushed into the body and the legs are expanded.

In the fastening structure according to the present invention, the shaft includes positioning projections projecting toward outside the legs in the non-expanded diameter state.

In the fastening structure according to the present invention, the positioning projections are continuous from distal ends of the legs to the body in the non-expanded diameter state, and grooves not to be located outside the legs in the expanded diameter state are formed at ends on the body sides of the positioning projections.

In the fastening structure according to the present invention, a pair of the arms projects from the body outward in directions away from each other, and in a second attached member temporary holding state in which the arms are inserted in the second attachment hole and are located opposite the first attached member with respect to the second attached member, and in the first attached member engagement state, the arms engage with the second attached member by making a positive rotation about the first engagement portion serving as an axis of rotation so as to establish the second attached member engagement state.

In the fastening structure according to the present invention, the arm includes a fitting projection that projects toward the second attached member in the second attached member temporary holding state, and the fitting projection is fitted into the second attached member in the second attached member engagement state.

In the fastening structure according to the present invention, the pin member includes a head and the shaft extending from the head, and the head has an inclined surface inclined outward toward the shaft.

In the fastening structure according to the present invention, the first attached member or the second attached member or the first and second attached members include a rotation restrictor that restricts the positive rotation in the second attached member engagement state, or restricts a negative rotation in a direction opposite to the direction of the positive rotation in the second attached member temporary holding state.

In the fastening structure according to the present invention, the second attached member includes a guide that guides sliding of the arm relative to the second attached member in a process from the second attached member temporary holding state to the second attached member engagement state.

In the fastening structure according to the present invention, the guide is an inclined surface that rises along the direction of the positive rotation from an edge of the second attachment hole.

In the fastening structure according to the present invention, a fitting recess into which the fitting projection is fitted is formed on the guide.

In the fastening structure according to the present invention, slits that engage with the positioning projections are formed at an edge of the first attachment hole.

A fastening structure according to the present invention is a fastening structure for attaching a second attached member to a first attached member facing the second attached member by being brought into a first attached member engagement state in which the fastening structure is inserted into a first attachment hole formed in the first attached member and engages with the first attached member and into a second attached member engagement state in which the fastening structure is inserted into a second attachment hole formed in the second attached member and engages with the second attached member. The fastening structure includes a grommet member and a pin member connected to each other in advance, in which the grommet member includes a body in which an insert hole is formed and that is attached to the first attached member, a plurality of legs that extends from around the insert hole and is inserted into the first attachment hole, and an arm that is formed opposite the legs with respect to the body and is inserted into the second attachment hole; the pin member includes a shaft inserted in the insert hole; and a first engagement portion including the legs and the shaft is brought into the first attached member engagement state by being inserted into the first attachment hole in a non-expanded diameter state capable of being inserted into the first attachment hole and being brought into an expanded diameter state in which the shaft is pushed into the body and the legs are expanded.

That is, in a state where the fastening structure is constituted by two members of the grommet member and the pin member (hereinafter, a member in which the grommet member is connected to the pin member is called “clip”) and the first engagement portion is inserted into the first attachment hole, when the legs of the grommet member are pushed from inside to be expanded, the first engagement portion is brought into the expanded diameter state and the fastening structure is brought into the first attached member engagement state. The first engagement portion is not engaged with the first attached member by elastic deformation of the legs, but the legs are pushed from inside to be expanded while being elastically deformed by the shaft. Therefore, the first engagement portion does not involuntarily return to the non-expanded diameter state. Thus, the first engagement portion is firmly attached to the first attached member, and the first attached member engagement state is robust. Since this state also prevents an involuntary rotation of the clip when the second attached member is attached, the second attached member is easily attached.

In the fastening structure according to the present invention, the shaft includes positioning projections projecting toward outside the legs in the non-expanded diameter state. If slits or the like for engaging with the positioning projections are formed at an edge of the first attachment hole, the posture of the first engagement portion when inserted into the first attachment hole is determined by the positioning projections and the slits or the like. Thus, the first engagement portion is prevented from being inserted into the first attachment hole in a wrong posture.

In the fastening structure according to the present invention, the positioning projections are continuous from distal ends of the legs to the body in the non-expanded diameter state, and grooves not to be located outside the legs in the expanded diameter state are formed at ends on the body sides of the positioning projections. In the non-expanded diameter state, the engagement of the positioning projections with the slits or the like of the first attachment hole prevents the involuntary rotation when the second attached member is attached. Therefore, the second attached member is easily attached. In contrast, in the expanded diameter state, the positioning projections pass through the slits or the like of the first attachment hole, and the grooves are located in the slits or the like. Therefore, the positioning projections do not engage with the slits or the like, thus allowing the clip to rotate positively. When the clip rotates positively, step portions at boundaries between the grooves and the positioning projections are displaced from the slits or the like, and the step portions engage with the first attached member even if the clip is pulled up. Thus, the clip is prevented from coming off the first attached member.

In the fastening structure according to the present invention, a pair of the arms projects from the body outward in directions away from each other, and in a second attached member temporary holding state in which the arms are inserted in the second attachment hole and are located opposite the first attached member with respect to the second attached member, and in the first attached member engagement state, the arms engage with the second attached member by making the positive rotation about the first engagement portion serving as an axis of rotation so as to establish the second attached member engagement state. That is, the positive rotation of the clip changes the state from the second attached member temporary holding state to a second attached member fitting state. Since the engagement is performed by the rotation that is an operation in a different direction from an insertion operation, the second attached member engagement state is more robust than when the engagement is performed only by insertion.

In the fastening structure according to the present invention, the arm includes a fitting projection that projects toward the second attached member in the second attached member temporary holding state, and the fitting projection is fitted into the second attached member in the second attached member engagement state. Thus, the second attached member engagement state is robust. For example, impact such as vibration is prevented from causing the involuntary rotation.

In the fastening structure according to the present invention, the pin member includes a head and the shaft extending from the head, and the head has an inclined surface inclined outward toward the shaft. When the head is passed through the second attachment hole to attach the second attached member, the edge of the second attachment hole is guided along the sloping surface. Therefore, the second attached member is easily attached.

In the fastening structure according to the present invention, the first attached member or the second attached member or the first and second attached members include a rotation restrictor that restricts the positive rotation in the second attached member temporary holding state, or restricts a negative rotation in a direction opposite to the direction of the positive rotation in the second attached member temporary holding state. Thus, the involuntary rotation of the clip is prevented and the second attached member is prevented from coming off.

In the fastening structure according to the present invention, the second attached member includes a guide that guides sliding of the arm relative to the second attached member in a process from the second attached member temporary holding state to the second attached member engagement state.

The arm follows the guide to facilitate the positive rotation. Therefore, the second attached member is easily attached.

In the fastening structure according to the present invention, the guide is an inclined surface that rises along the direction of the positive rotation from the edge of the second attachment hole. Since the arm slides smoothly along the inclined surface, no excessive stress is generated and the positive rotation is smoothly made. Therefore, the second attached member is easily attached.

In the fastening structure according to the present invention, a fitting recess into which the fitting projection is to be fitted is formed on the guide. Therefore, the second attached member engagement state is robust.

In the fastening structure according to the present invention, slits to engage with the positioning projections are formed at the edge of the first attachment hole. The posture of the first engagement portion when inserted into the first attachment hole is determined by the positioning projections and the slits. Therefore, the first engagement portion is prevented from being inserted into the first attachment hole in a wrong posture.

### BRIEF DESCRIPTION OF THE DRAWINGS

FIG. 1 is an exploded perspective view of a clip included in a fastening structure according to an embodiment of the present invention.

FIG. 2 is a perspective view of the clip included in the fastening structure according to the embodiment of the present invention.

FIG. 3 is a top view of the clip included in the fastening structure according to the embodiment of the present invention.

FIG. 4 is a front view of the clip included in the fastening structure according to the embodiment of the present invention.

FIG. 5 is a side view of the clip included in the fastening structure according to the embodiment of the present invention.

FIG. 6 is a bottom view of the clip included in the fastening structure according to the embodiment of the present invention.

FIG. 7 is a front view of the clip included in the fastening structure according to the embodiment of the present invention after being deformed.

FIG. 8 is a side view of the clip included in the fastening structure according to the embodiment of the present invention after being deformed.

FIG. 9 illustrates a section along IX-IX in FIG. 3 and is a sectional view of the clip included in the fastening structure according to the embodiment of the present invention.

FIG. 10 illustrates a section of the same composition as FIG. 9 and is a sectional view of the clip included in the fastening structure according to the embodiment of the present invention after being deformed.

FIG. 11 is a perspective view of a first attached member included in the fastening structure according to the embodiment of the present invention.

FIG. 12 is a perspective view of a second attached member included in the fastening structure according to the embodiment of the present invention.

FIG. 13 is a first fastening process front view illustrating a first process of fastening by the fastening structure according to the embodiment of the present invention.

FIG. 14 is a first fastening process front sectional view illustrating the first process of the fastening by the fastening structure according to the embodiment of the present invention.

FIG. 15 illustrates a section along XV-XV in FIG. 13 and is a first fastening process bottom sectional view illustrating the first process of the fastening by the fastening structure according to the embodiment of the present invention.

FIG. 16 is a second fastening process front view illustrating a second process of the fastening by the fastening structure according to the embodiment of the present invention. FIG. 17 is a second fastening process front sectional view illustrating the second process of the fastening by the fastening structure according to the embodiment of the present invention.

FIG. 18 illustrates a section along XVIII-XVIII in FIG. 13 and is a second fastening process bottom sectional view illustrating the second process of the fastening by the fastening structure according to the embodiment of the present invention.

FIG. 19 is a third fastening process front view illustrating a third process of the fastening by the fastening structure according to the embodiment of the present invention.

FIG. 20 is a third fastening process top view illustrating the third process of the fastening by the fastening structure according to the embodiment of the present invention.

FIG. 21 is a fourth fastening process front view illustrating a fourth process of the fastening by the fastening structure according to the embodiment of the present invention.

FIG. 22 is a fourth fastening process top view illustrating the fourth process of the fastening by the fastening structure according to the embodiment of the present invention.

FIG. 23 illustrates a section along XXIII-XXIII in FIG. 22 and is a fourth fastening process front sectional view illustrating the fourth process of the fastening by the fastening structure according to the embodiment of the present invention.

FIG. 24 is a fifth fastening process front view illustrating a fifth process of the fastening by the fastening structure according to the embodiment of the present invention.

FIG. 25 is a fifth fastening process top view illustrating the fifth process of the fastening by the fastening structure according to the embodiment of the present invention.

FIG. 26 illustrates a section along XXVI-XXVI in FIG. 25 and is a fifth fastening process front sectional view illustrating the fifth process of the fastening by the fastening structure according to the embodiment of the present invention.

### DETAILED DESCRIPTION OF EMBODIMENTS

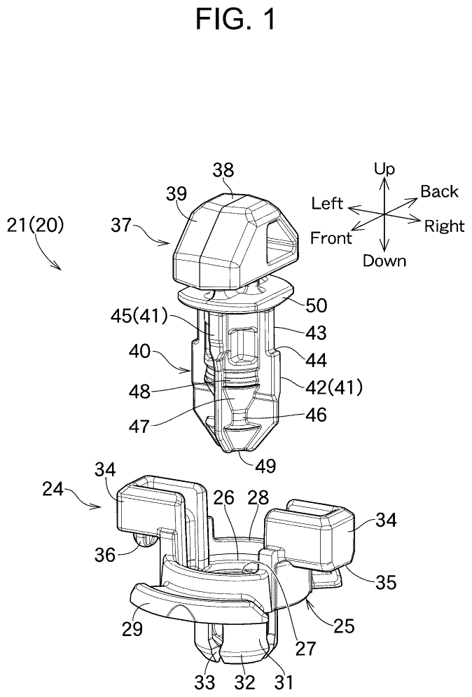

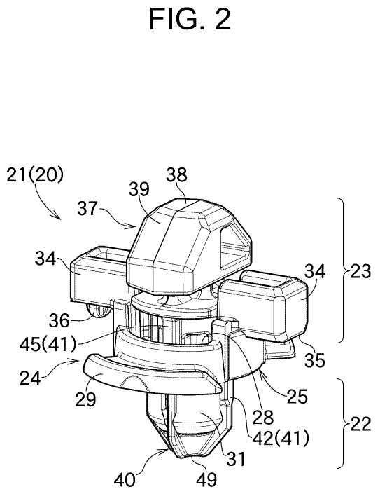

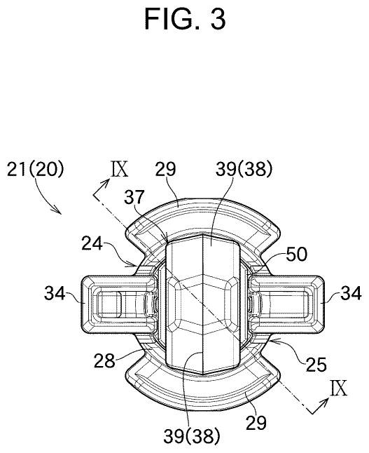

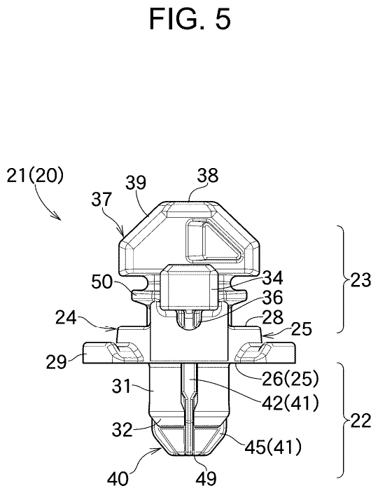

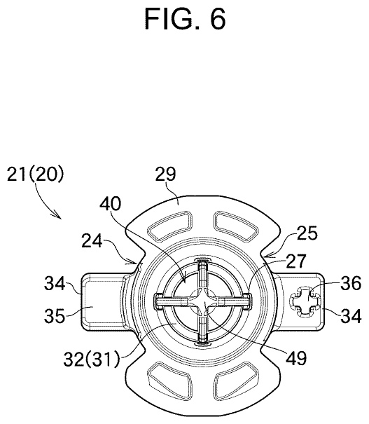

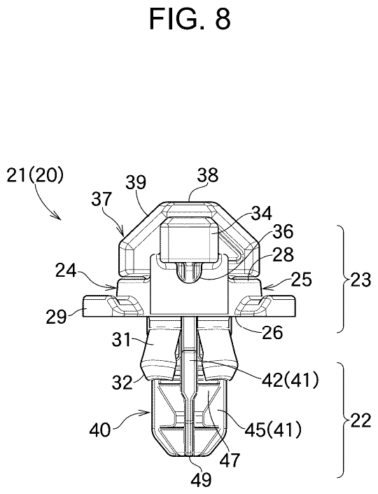

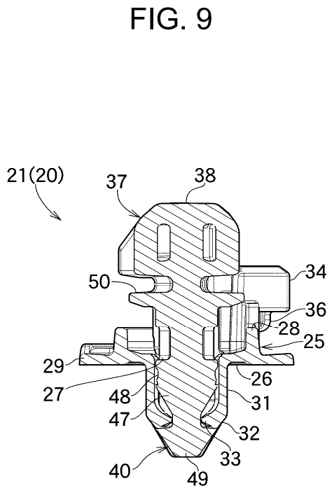

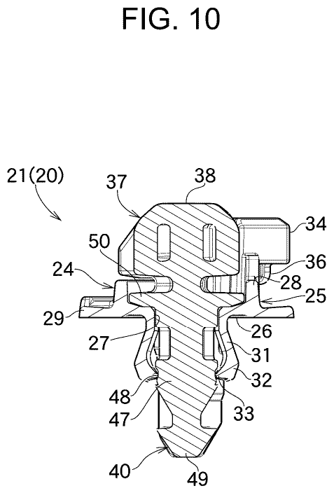

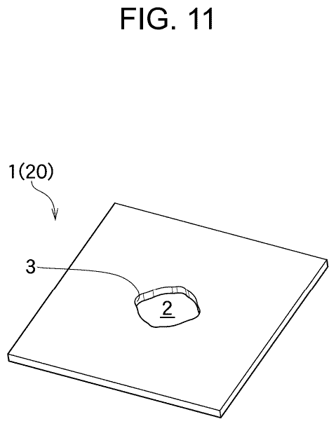

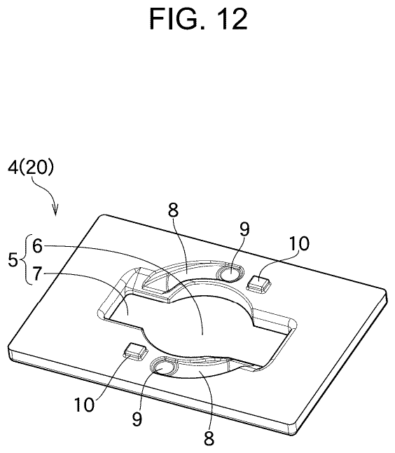

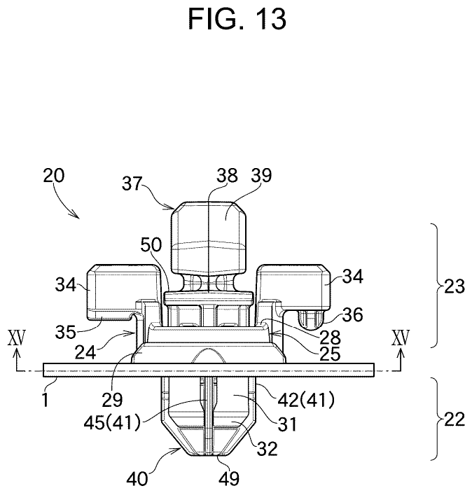

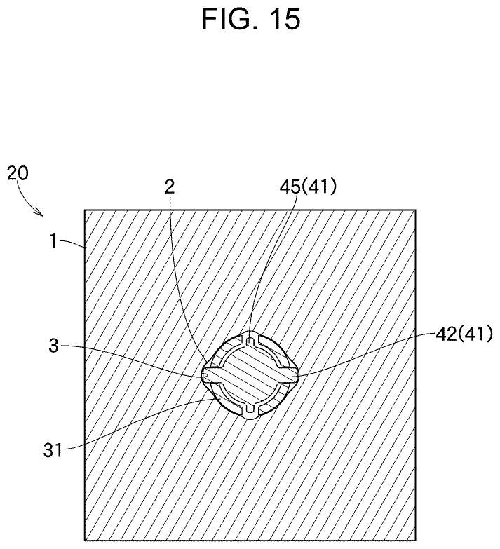

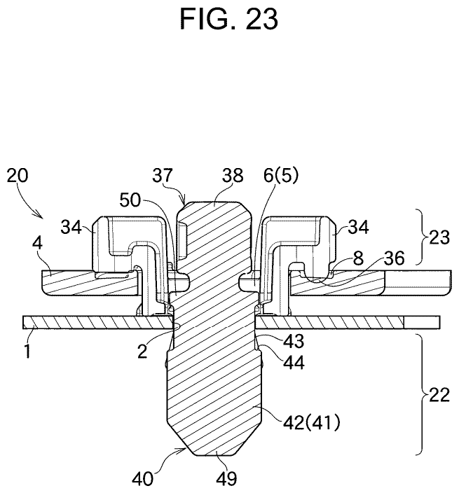

The following describes a fastening structure according to an embodiment of the present invention based on the drawings. A fastening structure 20 according to the present embodiment is, for example, a structure in which a second attached member 4, such as a lid cover (refer to FIG. 12), is attached to a first attached member 1, such as a sill cover (refer to FIG. 11), in a posture facing the first attached member 1 with a gap interposed therebetween, and the attached members 1 and 4 are connected together via a clip 21 (refer to FIG. 13 to 26). The clip 21 is constituted by two members of a grommet member 24 and a pin member 37 (refer to FIG. 1), and the grommet member 24 and the pin member 37 are connected to each other in advance (refer to FIG. 2). The grommet member 24 and the pin member 37 move and deform relative to each other in the connected state (refer to FIGS. 3 to 10). In the following description, “down” denotes a direction in which the pin member 37 is pushed into the grommet member 24; “up” denotes a direction in which the pin member 37 is pulled out of the grommet member 24; and “right”, “left”, “front”, and “back” denote lateral directions orthogonal to the up and down directions (refer to FIG. 1).

As illustrated in FIGS. 1 and 2, the clip 21 is used in a state where the two components are connected together in advance. As illustrated in FIG. 1, the pin member 37 includes a head 38, a shaft 40 that extends from the head 38 and is connected to the grommet member 24, and a pin flange 50 that is formed between the head 38 and the shaft 40 to restrict a movable range of the pin member 37 relative to the grommet member 24.

An inclined surface 39 is formed on the top surface of the head 38. A pair of the inclined surfaces 39 is formed and is inclined outward in the front and back directions as the position move downward in the direction toward the shaft 40.

The pin flange 50 has a flat plate shape and is located directly below the head 38.

The shaft 40 is connected to the bottom surface of the pin flange 50 and extends downward. A guide projection 41 and a guide groove 46 that guide the movement of the pin member 37 relative to the grommet member 24 and a raised portion 47 to deform the grommet member 24 are provided on the outer surface of the shaft 40. The guide projections 41 project outward in four directions of front, back, left, and right, and linearly extend up and down from the pin flange 50 to a lower end 49 of the shaft 40. The left and right guide projections 41 are positioning projections 42 that project more outward than the front and back guide projections 41, and the front and back guide projections 41 are non-positioning projections 45. Each of the positioning projections 42 is continuous from the pin flange 50 to the lower end 49, and a groove 43 is formed at a boundary portion with the pin flange 50. The groove 43 is recessed deeper than the positioning projection 42 toward the center of the shaft 40. A step 44 is formed at the boundary between the positioning projection 42 and the groove 43. Each of the non-positioning projections 45 is continuous from the pin flange 50 to the lower end 49.

The guide groove 46 is formed over from the pin flange 50 to the lower end 49 of the shaft 40 between the guide projections 41. The raised portion 47 is formed at a portion in the middle of the guide groove 46 and is raised toward a lateral outside of the guide groove 46 higher than the other portions of the guide groove 46. A portion of the raised portion 47 is recessed to form an engagement groove 48.

The grommet member 24 includes a body 25 connected to the pin member 37, a plurality of legs 31 extending from the body 25 and inserted into the first attached member 1, and an arm 34 formed on the body 25 and inserted into the second attached member 4.

The body 25 includes a disc-shaped substrate 26, a peripheral wall 28 rising from the circumferential edge of the substrate 26, and a body flange 29 extending from the peripheral wall 28. An insert hole 27 into which the shaft 40 of the pin member 37 is inserted is formed in the substrate 26. The insert hole 27 has a cruciform shape along the shape of the shaft 40 having four guide projections 41 of the pin member 37. The peripheral wall 28 has an annular shape along the circumference of the substrate 26. A pair of the body flanges 29 extends outward in the front and back directions from the lower end of the peripheral wall 28.

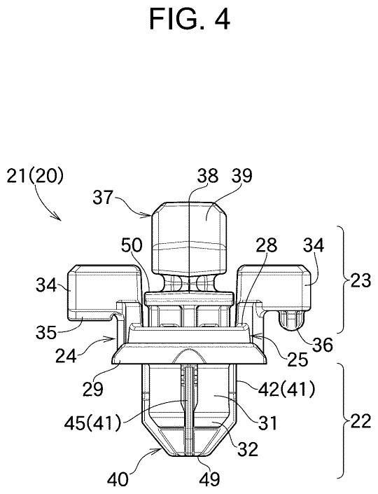

The legs 31 extend downward from around the insert hole 27. Inner projections 33 projecting inward are formed inside distal ends 32 that are the lower ends of the legs 31. A pair of the arms 34 is formed on the opposite side of the legs 31 with respect to the body 25. The arms 34 project from the upper end of the peripheral wall 28 outward in the left and right directions, in directions away from each other. A restricting projection 35 projecting downward is formed on the right arm 34. The bottom surface of the restricting projection 35 is a flat surface. A fitting projection 36 projecting downward is formed on the left arm 34. The fitting projection 36 is almost hemispherical and projects more than the restricting projection 35 (refer to FIG. 4).

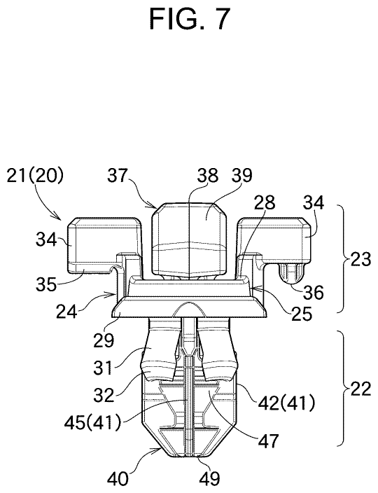

The shaft 40 of the pin member 37 is inserted from above into the insert hole 27 of the grommet member 24, and the pin member 37 is connected to the grommet member 24 to form the clip 21. In the clip 21, a first engagement portion 22 is formed from the legs 31 and the shaft 40, and a second engagement portion 23 is formed from the head 38 of the pin member 37 and the arms 34 of the grommet member 24. As illustrated in FIGS. 2 to 6, when the pin member 37 is located in an upper limit position with respect to the grommet member 24, the first engagement portion 22 is in a non-expanded diameter state. In the non-expanded diameter state, the legs 31 are in an initial posture of straightly extending downward, and the legs 31 are not pushed to expand laterally outward. As illustrated in FIGS. 7 to 10, when the pin member 37 is in a lower limit position with respect to the grommet member 24, the first engagement portion 22 is in an expanded diameter state. In the expanded diameter state, the shaft 40 is pushed into the body 25 and the legs 31 are pushed to expand laterally outward.

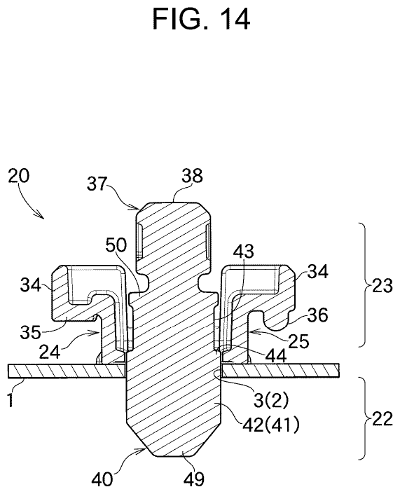

As illustrated in FIGS. 2 to 6, the guide projections 41 of the pin member 37 are located between the legs 31 of the grommet member 24 and are continuous from the body 25 of the grommet member 24 to the distal ends 32 of the legs 31. In the non-expanded diameter state, the positioning projections 42 of the guide projections 41 project in the left and right directions more outward than the legs 31. The groove 43 is formed at an end on the body 25 side of the positioning projection 42. Therefore, in the non-expanded diameter state, the groove 43 is located inside the body 25 (refer to FIG. 14). In contrast, the non-positioning projections 45 of the guide projections 41 do not project from the legs 31.

As illustrated in FIGS. 7 to 10, when the pin member 37 is pushed downward in the non-expanded diameter state, in the first engagement portion 22, the raised portion 47 of the shaft 40 pushes the inner projections 33 of the legs 31 laterally outward as the shaft 40 moves downward, thus expanding the legs 31 laterally outward. When the pin flange 50 of the pin member 37 abuts on the substrate 26 of the grommet member 24, the pin member 37 is restricted from moving downward, and at the same time, the inner projections 33 engage with the engagement groove 48 of the raised portion 47. Thus, the first engagement portion 22 is brought into the expanded diameter state.

The groove 43 of the pin member 37 is formed at an end on the body 25 side of the grommet member 24. Therefore, in the expanded diameter state, the groove 43 is exposed below the body 25 and is not located outside the legs 31 of the grommet member 24 (refer to FIG. 17).

The clip 21 is configured as described above. The following describes the first attached member 1 and the second attached member 4 connected together by the clip 21, based on the drawings.

As illustrated in FIG. 11, a portion of the first attached member 1 has a plate shape. That is, the first attached member 1 has a plate-like portion. A first attachment hole 2 is formed in the first attached member 1. The first attachment hole 2 is almost circular, but not exactly circular because a slit 3 is formed in a portion thereof. The first engagement portion 22 of the clip 21 is inserted into the first attachment hole 2, and the positioning projection 42 of the pin member 37 engages with the slit 3.

As illustrated in FIG. 12, a portion of the second attached member 4 has a plate shape. That is, the second attached member 4 has a plate-like portion. A second attachment hole 5 is formed in the second attached member 4, and a guide 8 and a rotation restrictor 10 are formed around the second attachment hole 5. The second engagement portion 23 of the clip 21 is inserted into the second attachment hole 5.

Therefore, the second attachment hole 5 has a shape along the second engagement portion 23, and has a circular hole 6 along the shape of the body 25 and the peripheral wall 28 of the grommet member 24, and a rectangular hole 7 along the shape of the arm 34 of the grommet member 24. The guide 8 facilitates a rotation of the clip 21. A pair of the guides 8 is upward inclined surfaces curved from the edges of the rectangular holes 7 along a circumference centered on the center of the circular hole 6. The guide 8 is a groove. Therefore, the foot of the guide 8 is located in a position deeper than the top surface in the direction of thickness of the attached member 4, and the top of the guide 8 is located near the top surface. A fitting recess 9 is formed at the top of the guide 8. The fitting recess 9 has a hemispherical shape along the shape of the fitting projection 36 of the arm 34. The rotation restrictor 10 restricts unnecessary rotation of the clip 21. A pair of the rotation restrictors 10 is located at the tips of the fitting projections 36 on the circumference of the circular hole 6. The rotation restrictors 10 protrude.

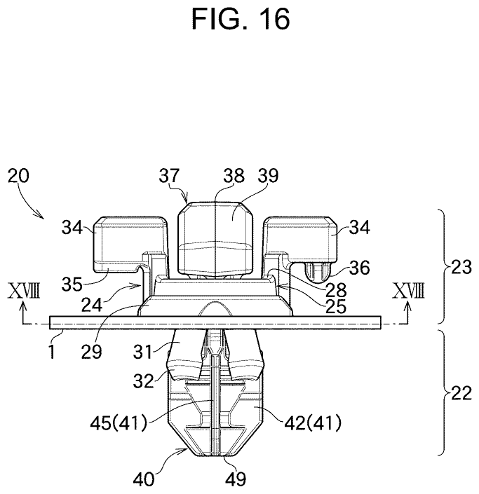

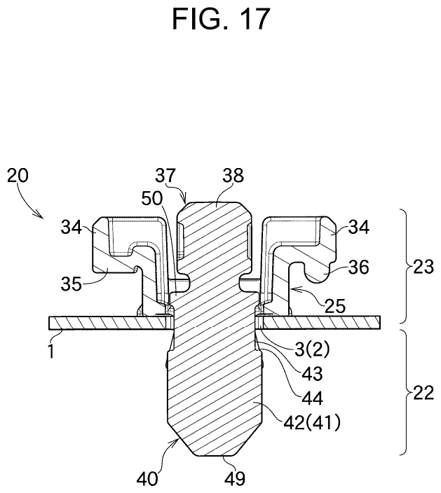

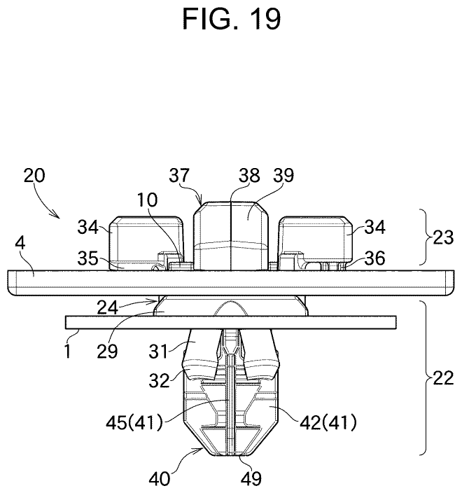

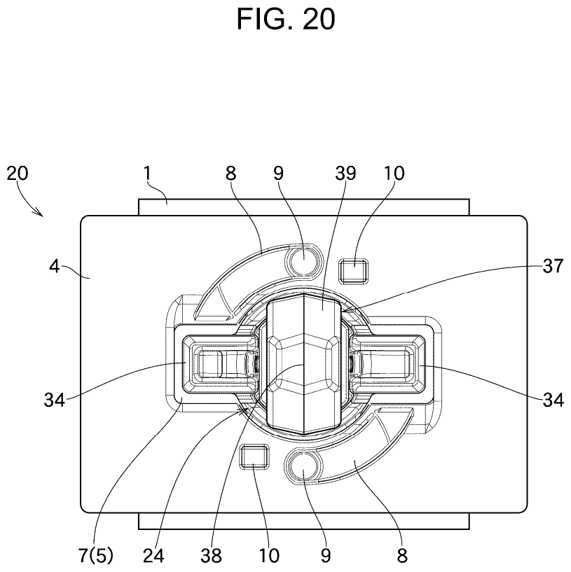

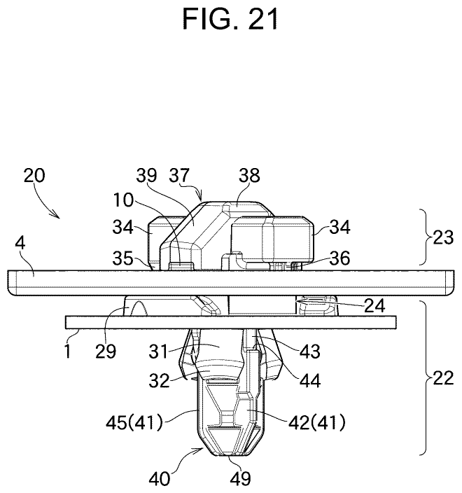

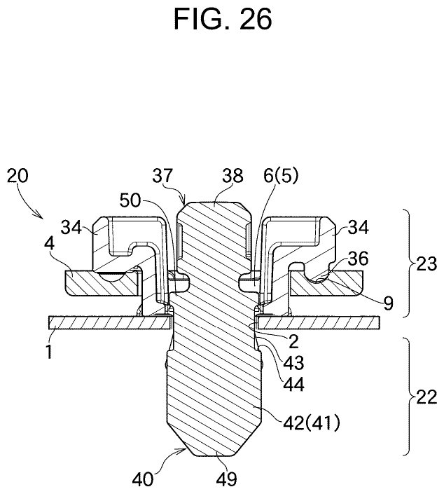

Each of the attached members 1 and 4 is configured as described above. The following describes a use procedure, operations, and effects of the fastening structure 20, based on the drawings. In the clip 21 before being attached to each of the attached members 1 and 4, the first engagement portion 22 is in the non-expanded diameter state (refer to FIGS. 2 to 7). By attaching the clip 21 to the first attached member 1, the clip 21 is brought into a first attached member temporary holding state (refer to FIGS. 13 to 15). In this state, when the first engagement portion 22 deforms into the expanded diameter state, the clip 21 engages with the first attached member 1 to be brought into a first attached member engagement state (refer to FIGS. 16 to 18). Then, the second attached member 4 is attached to the clip 21 to be brought into a second attached member temporary holding state (refer to FIGS. 19 and 20). In this state, when the clip 21 rotates, the clip 21 engages with the second attached member 4 to be brought into a second attached member engagement state (refer to FIGS. 21 and 26).

### First Attached Member Temporary Holding State

As illustrated in FIGS. 13 to 15, the first engagement portion 22 in the non-expanded diameter state is inserted into the first attachment hole 2 of the first attached member 1 to establish the first attached member temporary holding state. In the first attached member temporary holding state, the body 25 of the grommet member 24 is attached to the top surface of the first attached member 1. The first engagement portion 22 in the non-expanded diameter state can be inserted into the first attachment hole 2 because the legs 31 are not expanded. Since the positioning projection 42 of the pin member 37 projects laterally outward from the legs 31 of the grommet member 24, the positioning projection 42 can pass through the region of the slit 3 in the first attachment hole 2. Therefore, the posture of the first engagement portion 22 when inserted into the first attachment hole 2 is determined by the positioning projection 42 and the slit 3. Thus, the first engagement portion 22 is prevented from being inserted into the first attachment hole 2 in a wrong posture. Furthermore, when the positioning projection 42 is engaged with the slit 3, involuntary rotation of the clip 21 is also prevented when the second attached member 4 is attached to be brought into the second attached member temporary holding state. Therefore, the second attached member 4 can be easily attached.

### First Attached Member Engagement State

As illustrated in FIGS. 16 to 18, in the first attached member temporary holding state, the first engagement portion 22 is brought into the expanded diameter state to establish the first attached member engagement state. In the first attached member engagement state, when the pin member 37 is pushed into the grommet member 24, the shaft 40 widens the legs 31 of the grommet member 24 laterally outward, and the first engagement portion 22 is brought into the expanded diameter state. Since the legs 31 are pushed from inside to expand laterally outward while being elastically deformed by the shaft 40, the first engagement portion 22 does not involuntarily return to the non-expanded diameter state. Thus, the first engagement portion 22 is firmly attached to the first attached member 1, and the first attached member engagement state is robust. Since this state prevents the involuntary rotation of the clip 21 when the second attached member 4 is attached, the second attached member 4 is easily attached.

### Second Attached Member Temporary Holding State

As illustrated in FIGS. 19 and 20, the second engagement portion 23 is inserted into the second attachment hole 5 of the second attached member 4 to establish the second attached member temporary holding state. At this time, at a place where the head 38 of the pin member 37 passes through the second attachment hole 5, an edge of the second attachment hole 5 is guided along the inclined surface 39 of the head 38. Therefore, the second attached member 4 can be easily attached. In the second attached member temporary holding state, the arms 34 of the grommet member 24 are located on the top surface side that is the opposite side of the first attached member 1 with respect to the second attached member 4. The fitting projection 36 and the restricting projection 35 of the arms 34 protrude downward from the top surface side of the second attached member 4. The fitting projection 36 is located in the rectangular hole 7 of the second attachment hole 5 and is close to the foot of the guide 8. The restricting projection 35 is located above the rectangular hole 7 of the second attachment hole 5.

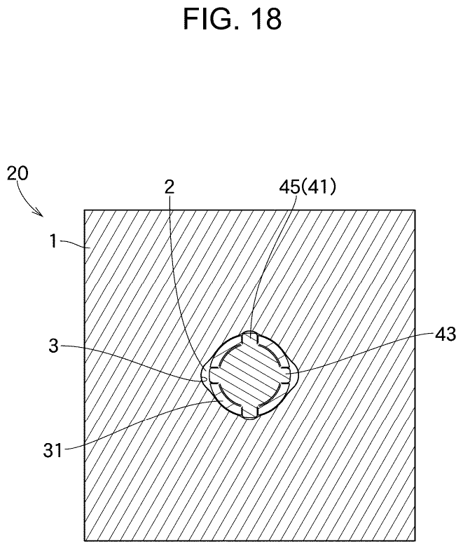

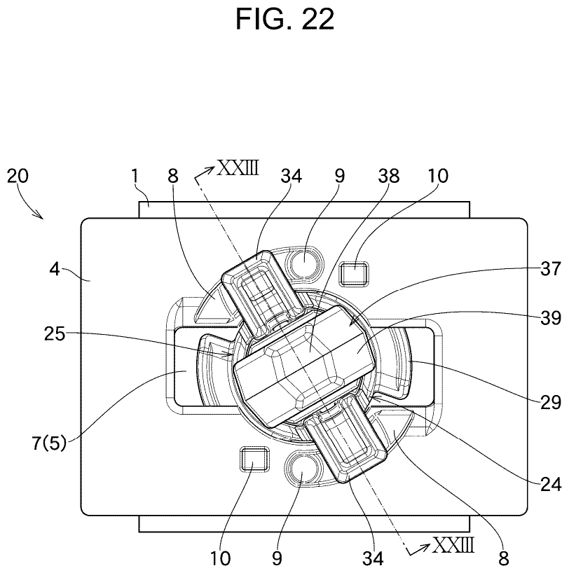

As illustrated in FIGS. 21 to 23, in the first attached member engagement state (expanded diameter state), the positioning projection 42 has passed through the slit 3 of the first attachment hole 2 and the groove 43 is located in the slit 3 (refer to FIG. 18). Therefore, the clip 21 can rotate positively (rotate clockwise in FIG. 22) about the first engagement portion 22 serving as the axis of rotation. The positive rotation of the clip 21 changes the state from the second attached member temporary holding state to the second attached member engagement state. Since the guide 8 of the second attached member 4 is an inclined surface that rises along the direction of the positive rotation, when the clip 21 rotates positively in the process from the second attached member temporary holding state to the second attached member engagement state, the fitting projection 36 of the grommet member 24 is guided along the guide 8 to the top of the guide 8. Since the fitting projection 36 is guided along the guide 8, the positive rotation is facilitated. In particular, since the fitting projection 36 smoothly slides along the inclined surface, the positive rotation is smoothly made without generating excessive stresses. Therefore, the second attached member 4 can be easily attached.

Since the fitting projection 36 of the grommet member 24 is located in the rectangular hole 7 of the second attachment hole 5, the fitting projection 36 abuts on an edge of the rectangular hole 7 (refer to FIG. 19) even if an external force is applied in the opposite direction of the positive rotation (direction of counterclockwise rotation in FIG. 22), so that involuntary negative rotation of the clip 21 is restricted.

As described above, in the first attached member engagement state and in the second attached member temporary holding state, the clip 21 rotates positively and the second engagement portion 23 engages with the second attached member 4, so that the second attached member engagement state is established. Since the second engagement portion 23 is engaged with the second attached member 4 by the rotation in the direction different from that for insertion into the second attachment hole 5, the second attached member engagement state is more robust than when the engagement is made only by insertion.

### Second Attached Member Engagement State

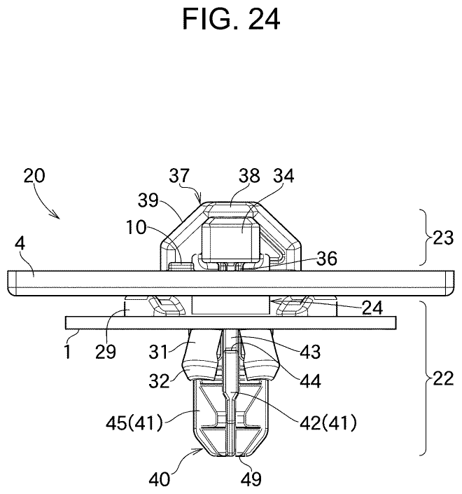

As illustrated in FIGS. 24 to 26, when the clip 21 has positively rotated approximately 90 degrees from the second attached member engagement state, the fitting projection 36 of the grommet member 24 engages with the fitting recess 9 of the guide 8 at the top of the guide 8 of the second attached member 4. Therefore, the second attached member engagement state is robust. When the clip 21 rotates positively, the step 44 at the boundary between the groove 43 and the positioning projection 42 of the pin member 37 is displaced from the slit 3 of the first attachment hole 2. In this state, if the clip 21 is pulled up, the step 44 engages with the first attached member 1 (refer to FIG. 26). Therefore, the clip 21 is prevented from coming off the first attached member 1.

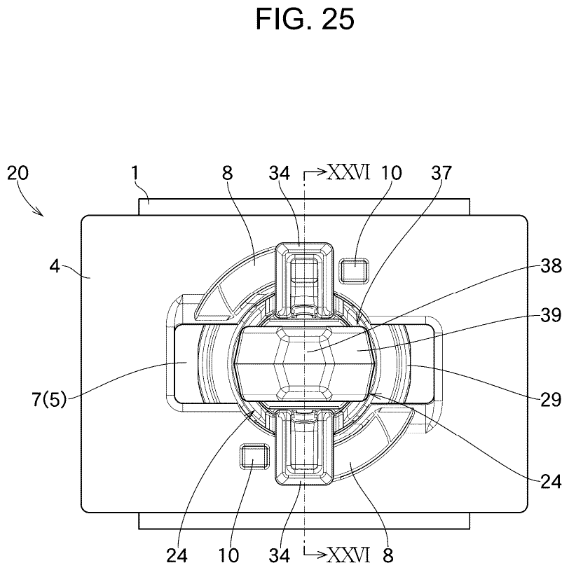

The rotation restrictor 10 is present on a circular orbit of the arm 34 when the clip 21 rotates positively (refer to FIG. 25). Therefore, even if an addition external force is applied to the clip 21 in the direction in which the clip 21 rotates positively in the second attached member engagement state, the restricting projection 35 and the fitting projection 36 abut on the rotation restrictor 10, so that the clip 21 is restricted from involuntarily rotating positively.

In another embodiment according to the present invention, in the pin member, the front and back guide projections are the positioning projections.

In another embodiment, in the pin member, all the front, back, left, and right guide projections are the positioning projections.

In another embodiment, in the pin member, any one of the front, back, left, and right guide projections is the positioning projection.

In another embodiment, the inclined surface has a single surface, or three or more surfaces. The inclined surface has, for example, a conical shape, or a polygonal shape, such as a triangular pyramid shape.

In another embodiment, in the pin member, the head has no inclined surface.

In another embodiment, in the grommet member, the number of the arms is any number.

In another embodiment, in the grommet member, the restricting projection is formed on the right arm, and the fitting projection is formed on the left arm.

In another embodiment, in the grommet member, the arms protrude outward in the front and back directions.

In another embodiment, in the grommet member, the fitting projections are formed on both of the arms.

In another embodiment, in the grommet member, the fitting projection may have any shape, for example, a semicircular shape (what is called a semicylindrical shape) or the like in section. In this case, the fitting recess of the second attached member also has a shape along the shape of the fitting projection.

In another embodiment, the grommet member has no fitting projection, and the second attached member has no fitting recess. In this case, the arm of the grommet member slides in contact with the second attached member and the arm engages with the second attached member.

In another embodiment, the first attached member includes the rotation restrictor. In this case, the rotation restrictor is located on the circular orbit of the body flange when the clip rotates on the top surface of the first attached member, and the body flange abuts on the rotation restrictor to restrict the involuntary positive or negative rotation of the clip.

In another embodiment, when the clip reversely rotates, the restricting projection and/or the fitting projection of the arm abut/abuts on the rotation restrictor to restrict the involuntary negative rotation of the clip.

In another embodiment, the first and the second attached members each include the rotation restrictor.

In another embodiment, the second attached member include no rotation restrictor.

In another embodiment, the guide is not an inclined surface in the second attached member.

In another embodiment, the second attached member has no guide.

Although the embodiment of the present invention has been described in detail above, the present invention is not limited to the embodiment described above. The present invention can be modified in design in various ways as long as not deviating from the matters described in the claims.

What is claimed is:

1. A fastening structure for attaching a second attached member to a first attached member facing the second attached member by being brought into a first attached member engagement state in which the fastening structure is inserted into a first attachment hole formed in the first attached member and engages with the first attached member and into a second attached member engagement state in which the fastening structure is inserted into a second attachment hole formed in the second attached member and engages with the second attached member,
the fastening structure comprising a grommet member and a pin member connected to each other in advance, wherein
the grommet member comprises:
a body in which an insert hole is formed, the body being configured to be attached to the first attached member;
a plurality of legs that extends from around the insert hole and is configured to be inserted into the first attachment hole; and
an arm that is formed opposite the legs with respect to the body and is configured to be inserted into the second attachment hole,
the pin member comprises a shaft inserted in the insert hole, and
a first engagement portion comprising the legs and the shaft is configured to be brought into the first attached member engagement state, by being inserted into the first attachment hole in a non-expanded diameter state capable of being inserted into the first attachment hole and being brought into an expanded diameter state in which the shaft is pushed into the body and the legs are expanded.

2. The fastening structure according to claim 1, wherein the shaft comprises positioning projections projecting toward outside the legs in the non-expanded diameter state.

3. The fastening structure according to claim 2, wherein
the positioning projections are continuous from distal ends of the legs to the body in the non-expanded diameter state, and
grooves configured not to be located outside the legs in the expanded diameter state are formed at ends on the body sides of the positioning projections.

4. The fastening structure according to claim 1, wherein
a pair of the arms projects from the body outward in directions away from each other, and
in the second attached member temporary holding state in which the arms are inserted in the second attachment hole and are located opposite the first attached member with respect to the second attached member, and in the first attached member engagement state, the arms are configured to engage with the second attached member by making a positive rotation about the first engagement portion serving as an axis of rotation so as to establish the second attached member engagement state.

5. The fastening structure according to claim 2, wherein
a pair of the arms projects from the body outward in directions away from each other, and
in the second attached member temporary holding state in which the arms are inserted in the second attachment hole and are located opposite the first attached member with respect to the second attached member, and in the first attached member engagement state, the arms are configured to engage with the second attached member by making a positive rotation about the first engagement portion serving as an axis of rotation so as to establish the second attached member engagement state.

6. The fastening structure according to claim 3, wherein
a pair of the arms projects from the body outward in directions away from each other, and
in the second attached member temporary holding state in which the arms are inserted in the second attachment hole and are located opposite the first attached member with respect to the second attached member, and in the first attached member engagement state, the arms are configured to engage with the second attached member by making a positive rotation about the first engagement portion serving as an axis of rotation so as to establish the second attached member engagement state.

7. The fastening structure according to claim 4, wherein
the arm comprises a fitting projection configured to project toward the second attached member in the second attached member temporary holding state, and
the fitting projection is configured to be fitted into the second attached member in the second attached member engagement state.

8. The fastening structure according to claim 5, wherein
the arm comprises a fitting projection configured to project toward the second attached member in the second attached member temporary holding state, and
the fitting projection is configured to be fitted into the second attached member in the second attached member engagement state.

9. The fastening structure according to claim 6, wherein
the arm comprises a fitting projection configured to project toward the second attached member in the second attached member temporary holding state, and
the fitting projection is configured to be fitted into the second attached member in the second attached member engagement state.

10. The fastening structure according to claim 1, wherein
the pin member comprises a head and the shaft extending from the head, and
the head has an inclined surface inclined outward toward the shaft.

11. The fastening structure according to claim 2, wherein
the pin member comprises a head and the shaft extending from the head, and
the head has an inclined surface inclined outward toward the shaft.

12. The fastening structure according to claim 3, wherein
the pin member comprises a head and the shaft extending from the head, and
the head has an inclined surface inclined outward toward the shaft.

13. The fastening structure according to claim 4, wherein the first attached member or the second attached member or the first and second attached members comprise a rotation restrictor configured to restrict the positive rotation in the second attached member engagement state, or restrict a negative rotation in a direction opposite to the direction of the positive rotation in the second attached member temporary holding state.

14. The fastening structure according to claim 5, wherein the first attached member or the second attached member or the first and second attached members comprise a rotation restrictor configured to restrict the positive rotation in the second attached member engagement state, or restrict a negative rotation in a direction opposite to the direction of the positive rotation in the second attached member temporary holding state.

15. The fastening structure according to claim 6, wherein the first attached member or the second attached member or the first and second attached members comprise a rotation restrictor configured to restrict the positive rotation in the second attached member engagement state, or restrict a negative rotation in a direction opposite to the direction of the positive rotation in the second attached member temporary holding state.

16. The fastening structure according to claim 7, wherein the second attached member comprises a guide configured to guide sliding of the arm relative to the second attached member in a process from the second attached member temporary holding state to the second attached member engagement state.

17. The fastening structure according to claim 8, wherein the second attached member comprises a guide configured to guide sliding of the arm relative to the second attached member in a process from the second attached member temporary holding state to the second attached member engagement state.

18. The fastening structure according to claim 16, wherein the guide is an inclined surface that rises along the direction of the positive rotation from an edge of the second attachment hole.

19. The fastening structure according to claim 16, wherein a fitting recess into which the fitting projection is fitted is formed on the guide.

20. The fastening structure according to claim 2, wherein slits configured to engage with the positioning projections are formed at an edge of the first attachment hole.
